(19) United States
(12) Patent Application Publication
(10) Pub. No.: US 2022/0360940 A1
(43) Pub. Date: Nov. 10, 2022

(54) ELECTRONIC DEVICE AND OPERATION METHOD OF ELECTRONIC DEVICE DETERMINING LOCATION OF ELECTRONIC DEVICE

(71) Applicant: Samsung Electronics Co., Ltd., Gyeonggi-do (KR)

(72) Inventors: Sunggyu YIM, Gyeonggi-do (KR); Myeongwoo KOO, Gyeonggi-do (KR); Yunhwa SEO, Gyeonggi-do (KR); Sunggyu LEE, Gyeonggi-do (KR)

(21) Appl. No.: 17/740,760

(22) Filed: May 10, 2022

Related U.S. Application Data
(63) Continuation of application No. PCT/KR2022/005667, filed on Apr. 20, 2022.

(30) Foreign Application Priority Data
May 4, 2021 (KR) 10-2021-0057945

(51) Int. Cl. H04W 4/02; H04W 4/021

(52) U.S. Cl. CPC H04W 4/027; H04W 4/021; H04W 4/023

(57) ABSTRACT

An electronic device and method are disclosed within. The electronic device includes a location sensor, a memory, a communication module, and a processor. The processor implements the method, including receiving, from the communication module, identification information of one or more external electronic devices included in a primary geo-fence, and relative distances between each of the one or more external electronic devices and the electronic device, determining respective locations of the one or more external electronic devices, based on a location of the electronic device as detected via the location sensor, and the relative distances, and defining a portion of the primary geo-fence as a secondary geo-fence inclusive of the one or more external electronic devices, based at least on the identification information and the respective locations of the one or more external electronic devices.

### CROSS-REFERENCE TO RELATED APPLICATION(S)

This application is a continuation of International Application No. PCT/KR2022/005667, which was filed on Apr. 20, 2022 and claims priority to Korean Patent Application No. 10-2021-0057945, filed on May 4, 2021, in the Korean Intellectual Property Office, the disclosures of which are incorporated by reference herein their entirety.

### BACKGROUND

### Technical Field

Certain embodiments disclosed in this document relate to location identification in electronic devices, and, more particularly, geofencing.

### Background Art

Geofencing involves generation of virtual boundaries and defining virtual areas for real-world spaces. Geofencing may involve geo-location, in tandem with wireless communication technology, such as Bluetooth, Wi-Fi, long-term evolution (LTE) (e.g., 4^{th} generation mobile communication), and/or new radio (NR) (5^{th} generation mobile technology), and beyond.

Geofencing may be used to detect whether a device has entered a predetermined area, based on a detected location of the device, and perform a consequent operation, such as some texting operation, emailing operation, or notification operation, according to some condition related to entry into the predetermined area.

For example, geofencing can be used to detect whether another user (e.g., via social media) is located near the present user, in which case they may be notified of the proximity of the other user. Furthermore, corporate targeted marketing, push-alarm advertisements, etc. may be transmitted upon detecting entry into a certain area (e.g., a retail center, etc.).

Geofencing may also be used in smart-home technology, such as by automatically setting a thermostat temperature when the user arrives within a certain proximity to the home, or automating activation of certain devices, such as washing machines and other such appliances.

Geofencing often uses global positioning satellite systems (GPS) for tracking locations and/or movements of an electronic device. However, GPS signals are often reliant on straightness (e.g., line of sight) and do not adapt well to diffraction and refraction. Thus, it may be difficult to utilize a GPS signal indoors. This makes usage of secondary location detection via, e.g., LTE and 5G beneficial, but these often involve high power consumption. Thus, geofencing is difficult to implement for indoor spaces, and may generate excessive power consumption. Furthermore, it is limited in fencing radius (e.g., typically about 100-200 m), and thus it is often difficult to set smaller and more granular geofenced areas.

### SUMMARY

Certain embodiments of the disclosure may implement a geo-fence technology for creating detailed, granular, subdivided indoor areas based on locations of external electronic devices which communicate with an electronic device.

For example, an electronic device according to certain embodiments may communicate with an external electronic device to acquire identification information of the external electronic device, and a relative distance to the external electronic device. The electronic device may generate location information of the external electronic device based on the location of the electronic device and information on the external electronic device, and identify a geo-fence area based on the information on the external electronic device.

For example, the electronic device may communicate with an external electronic device such as a smart device providing an Internet of things (IoT) function, to transmit and/or receive various pieces of information. The smart device may include various types such as a wearable device (for example, a smart watch, a hearable, or a smart ring) worn on the body, a nearable device (for example, smart weight scale or smart speaker), or home appliances (for example, TV, refrigerator, washing machine, or dishwasher). The electronic device may acquire identification information of the smart device and a relative distance thereto through a communication module. The electronic device may acquire location information of the smart device based on information on the smart device, and process a location of the smart device to generate a geo-fence table. The electronic device may identify information for a smart device connected within the predetermined in the geo-fence table, and thereby acquire information on an area in which the electronic device is located.

For example, a geo-fence may be divide the interior of a user's house into detailed fencing areas, using labeling like “kitchen,” “living room,” “main room,” “room1,” and “room2, ” and the electronic device may communicate with smart devices located in each respective area. The electronic device may scan for smart devices located in each area and store identification information for the smart devices for each area in the geo-fence table. For example, when the electronic device is located in the living room, the electronic device may be connected to a smart device such as a TV or a living room air-conditioner. The electronic device may retrieve identification information of the connected smart device in the geo-fence table and determine that the electronic device is located in the living room. When it is identified that the electronic device is in the living room, an application applying the geo-fence may provide a user interface (UI) capable of controlling the smart device located in the living room.

As described above, the geo-fence technology for subdividing indoor spaces may provide various services to enhance the convenience of the user.

The technical subjects pursued in the present disclosure are not limited to the above mentioned technical subjects, and other technical subjects which are not mentioned may be clearly understood through the following descriptions by those skilled in the art of the present disclosure.

An electronic device according to certain embodiments of the disclosure includes a location sensor, a memory, a communication module, and a processor operatively coupled to the same, the processor configured to: receive, from the communication module, identification information of one or more external electronic devices included in a primary geo-fence, and relative distances between each of the one or more external electronic devices and the electronic device, determine respective locations of the one or more external electronic devices, based on a location of the electronic device as detected via the location sensor, and the relative distances, and define a portion of the primary geo-fence as a secondary geo-fence inclusive of the one or more external electronic devices, based at least on the identification information and the respective locations of the one or more external electronic devices.

An electronic device according to certain embodiments of the disclosure includes a communication module and a processor operatively connected to the communication module, wherein the processor is configured to receive information on an external electronic device, including identification information for an external electronic device, via the communication module, search a secondary geo-fence included in a primary geo-fence, for the identification information of the external electronic device, based on detecting the identification information in the secondary geo-fence, identify a validity state of the external electronic device indicating whether location information of the external electronic device can be used for geo-fence determination, and when the identified validity state indicates availability, determine whether the electronic device is located in a predetermined area based at least on the location information of the external electronic device.

A method according to certain embodiments of the disclosure includes: acquiring, via communication circuitry, identification information of one or more external electronic devices included in a primary geo-fence, acquiring, via at least one processor, respective relative distances between each of the one or more external electronic devices and the electronic device, determining respective locations of each the one or more external electronic devices, based at least on a location of the electronic device and the respective relative distances, and defining at least a portion of the primary geo-fence as a secondary geo-fence inclusive of the one or more external electronic devices, based at least on the identification information and the respective locations of the one or more external electronic devices. A method according to certain embodiments of the disclosure includes: acquiring, via communication circuitry, information on an external electronic device including identification information, searching in a secondary geo-fence included in a primary geo-fence for the identification information, based on detecting the identification information in the secondary geo-fence, identifying a validity state of the external electronic device, indicating whether location information of the external electronic device can be used for geo-fence determination, and when the identified validity state indicates availability, determining whether the electronic device is located in a predetermined area based on the location information of the external electronic device.

An electronic device can provide geo-fence technology for usage and identification of granular subdivided indoor areas.

The electronic device may provide a geo-fence technology in environments in which GPS and local network communication is limited or unavailable, using IoT device infrastructure instead.

The electronic device may reduce an amount of battery consumption of the electronic device, by bypassing usage of connection to GPS and/or local network communications.

The electronic device may enhance user convenience through geo-fence-related services having greater detail and granularity in subdividing indoor and/or outdoor areas.

### BRIEF DESCRIPTION OF THE DRAWINGS

In connection with a description of drawings, the same or similar reference numerals may be used for the same or similar elements.

FIG. 1 is a block diagram illustrating an electronic device within a network environment according to certain embodiments.

FIG. 2 is a block diagram illustrating an electronic device according to certain embodiments.

FIG. 3 is a block diagram illustrating an external electronic device according to certain embodiments.

FIG. 4 is a flowchart illustrating a method by which a processor processes location information of the external electronic device according to certain embodiments.

FIG. 5 illustrates an operation in which the processor determines a reliable location radius in order to determine whether a location of the electronic device is reliable according to certain embodiments.

FIG. 6A illustrates an operation in which the processor scans for external electronic devices according to certain embodiments.

FIG. 6B is an operation in which a fixed external electronic device scans for external electronic devices according to certain embodiments.

FIG. 6C illustrates an operation in which the processor determines accuracy of the external electronic device according to certain embodiments of the disclosure.

FIG. 7A illustrates an operation in which the processor determines a validity state according to certain embodiments.

FIG. 7B illustrates an operation in which the processor leans information through machine learning according to certain embodiments of the disclosure.

FIG. 8 illustrates an example of a server according to certain embodiments.

FIG. 9 is a flowchart illustrating a method by which the processor scans for external electronic devices and determines whether the external electronic devices are located in a predetermined area according to certain embodiments.

FIGS. 10A, 10B, 10C, and 10D illustrate a method by which the processor determines whether the electronic device is located in a predetermined area according to certain embodiments.

### DETAILED DESCRIPTION

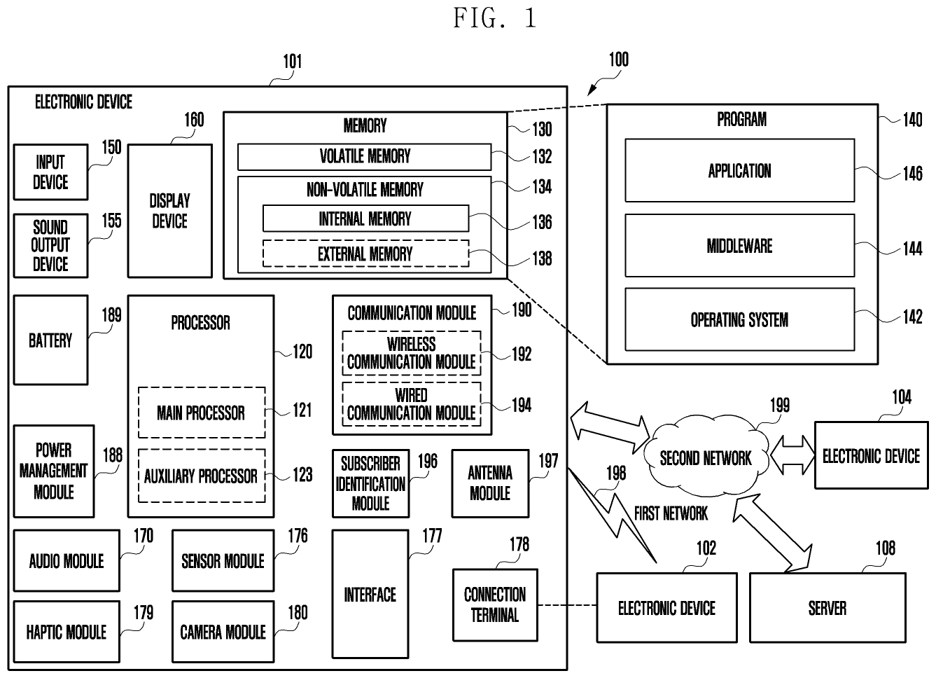

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element implemented using a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

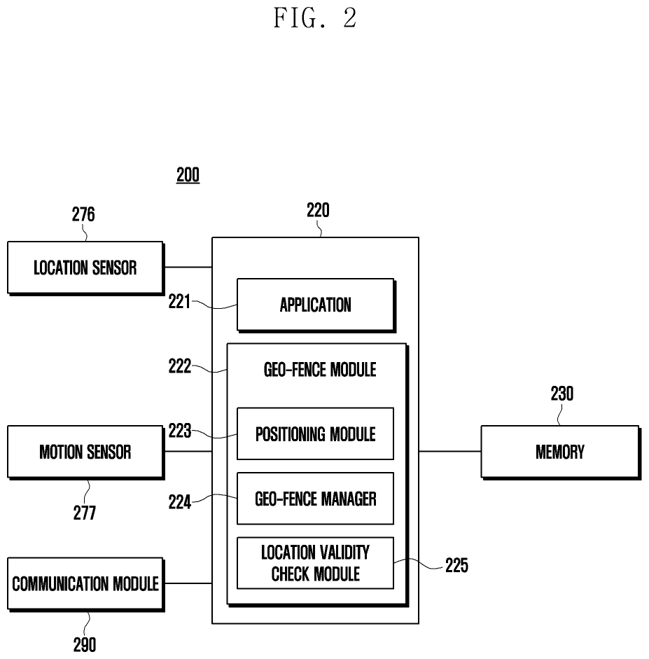

FIG. 2 is a block diagram illustrating an electronic device according to certain embodiments.

Referring to FIG. 2, an electronic device 200 (for example, the electronic device 101 of FIG. 1) may include a processor 220 (for example, the processor 120 of FIG. 1), a memory 230 (for example, the memory 130 of FIG. 1), a location sensor 276, a motion sensor 277, and/or a communication module 290 (for example, the communication module 190 of FIG. 1). The elements included in FIG. 2 are some of the elements included in the electronic device 200, and the electronic device 200 may include various other elements as illustrated in FIG. 1.

The communication module 290 according to an embodiment may communication with an external electronic device (for example, the electronic device 102 and/or the electronic device 104 of FIG. 1) and/or a server (for example, the server 108 of FIG. 1) through a network (for example, the first network 198 and/or the second network 199 of FIG. 1) to receive and/or transmit various pieces of information. For example, the communication module 290 may communicate with an external electronic device (for example, a smart device) through a network (for example, UWB, BT, and/or Wi-Fi) to transmit and/receive various pieces information. The processor 220 may be connected to the communication module 290 and process the various pieces of information which the communication module 290 receives from the external electronic device. Further, the processor 220 may control the communication module 290 to transmit various pieces of information to the external electronic device. For example, the communication module 290 may acquire identification information (for example, basic service set identification (BSSID) or network ID) of a neighboring external electronic device (for example, a smart device) and a relatively distance between the electronic device 200 and the external electronic device and provide the same to the processor 220 in response to a request for scanning for the neighboring external electronic device of the processor 220 (for example, the smart device). For example, the communication module 290 may transmit a signal making a request for identification information to the external electronic device, receive information including the identification information from the external electronic device, and acquire the identification information of the external electronic device. For example, the communication module 290 may acquire the relative distance between the electronic device 200 and the external electronic device on the basis of the strength of the signal acquired from the external electronic device. For example, the communication module 290 may acquire a relative distance to the external electronic device 300 on the basis of a characteristic of a signal exchanged between the electronic device 200 and the external electronic device 300 (for example, a characteristic of difference between a transmission time and a reception time of the signal or a characteristic related to the magnitude of the signal (received signal received power (RSRP) and/or a received signal strength indicator (RSSI))).

The location sensor 276 according to an embodiment may measure a geographical location of the electronic device 200. For example, the location sensor 276 may include a GNSS (for example, global positioning system (GPS) and/or global navigation satellite system (GLONASS)) and/or Wi-Fi positioning system (WPS). For example, the GNSS may be a system for measuring the current location on the basis of radio waves radiated from a plurality of satellites through a GPS sensor and/or a GLONASS sensor. The WPS may be a system for measuring the indoor location on the basis of radio AP information recognized by Wi-Fi. GPS information may include accuracy area based on latitude, longitude, and/or the corresponding location, and may be expressed as a circle in which the latitude and the longitude form the central point, and a numeric value of the accuracy sets the radius of the circle. The processor 220 according to an embodiment may be connected to the location sensor 276 to generate a request for measuring the location of the electronic device 200, and the location sensor 276 may provide the measured location information of the electronic device 200 to the processor 220.

The motion sensor 277 according to an embodiment may measure activities of the electronic device 200 to measure a signal related to a movement distance of the electronic device 200. For example, the processor 220 may identify the movement distance of the electronic device 200 on the basis of a activity recognition type based on the signal measured by the motion sensor 277 (for example, stationary, walk, run, vehicle, and cycle) and/or a duration time of the activity. According to an embodiment, the motion sensor 277 may be operated by a sub processor (for example, sensor hub) rather than a main processor (for example, application processor) in order to reduce battery consumption of the electronic device 200.

The memory 230 may temporarily and/or non-temporarily store information processed by the processor 220. For example, the memory 230 may store identification information of the external electronic device 300 processed by the processor 220, the relative distance between the electronic device 200 and the external electronic device 300, and/or location information of the external electronic device 300 based on the location information of the electronic device 200. Further, the memory 230 may store information related to identification information, latitude, longitude, accuracy, a valid count, and/or a move count of the external electronic device 300 included in a location information table generated by the processor 220. In addition, the memory 230 may store identification information, a geo-fence ID, a validity state, and/or user identification of the external electronic device 300 included in a geo-fence table generated by the processor 220. Information temporarily and/or non-temporarily stored in the memory 230 may be transmitted to the external electronic device 300 and/or the server 108 through the communication module 290.

The server (for example, the server 108 of FIG. 1) may manage account information related to the predetermined area (geo-fence) and share geo-fence information with electronic devices linked to the account. When a change in geo-fence information is detected by learning (e.g., as used in the disclosure, “learning” refers to machine learning) in a predetermined electronic device or by user settings, the server 108 may synchronize the changed information with the electronic device linked to the account. For example, when an original data table, a location information table, and/or a geo-fence table are changed by at least one electronic device connected to the account, the server 108 may synchronize the changed information with another electronic device linked to the corresponding account.

The processor 220 may be operatively connected to the location sensor 276, the motion sensor 277, the communication module 290, and/or the memory 230 to generate a request for and/or process various pieces of information.

According to certain embodiments, the processor 220 may include an application 221, a geo-fence module 222, a positioning module 223, a geo-fence manager 224 and/or a location validity check module 225.

According to an embodiment, the application 221 may be an application for performing a predetermined operation on the basis of the result of determination about access to a predetermined area (for example, geo-fence). Geo-fence information may include a primary geo-fence and a secondary geo-fence dependent on the primary geo-fence and divide detailed areas. According to an embodiment, the primary geo-fence may be a virtual geographical area set on the basis of a GPS, and the secondary geo-fence may be a predetermined area in detail by the user within the primary geo-fence. The primary geo-fence may include at least one secondary geo-fence. According to an embodiment, the application 221 may acquire geo-fence information including latitude, longitude, and/or radius of the central point related to the predetermined area from the server and/or the memory 230. The application 221 may transfer geo-fence information including the primary geo-fence and/or the secondary geo-fence to the geo-fence module 222 and acquire the result of determination about access to the predetermined area (for example, geo-fence). According to an embodiment, the application 221 may acquire an identification information list of the external electronic device 300 which can be used for determining access to the predetermined area through the geo-fence manager 224 and update the identification information of in the identification information list identified by the user in the geo-fence manager 224 to generate the secondary geo-fence. The application 221 may update the generated secondary geo-fence list in the server (for example, the server 108 of FIG. 1).

The geo-fence module 222 according to an embodiment may determine access to the predetermined area on the basis of location information of the electronic device 200 and/or information on the external electronic device 300. For example, geo-fence module 222 may determine whether access to the predetermined area is conducted on the basis of identification that the location information of the electronic device 200 is with a predetermined distance from the external electronic device 300 corresponding to the predetermined area. The geo-fence module 222 according to an embodiment may include the positioning module 223, the geo-fence manager 224 and/or the location validity check module 225.

The positioning module 223 according to an embodiment may generate location information of the external electronic device 300 on the basis of location information of the electronic device 200 acquired from the location sensor 276 and/or information on the external electronic device 300 (for example, identification information and/or relatively distance) acquired from the communication module 290. For example, the location information of the external electronic device 300 may include identification information, latitude, longitude, and/or accuracy of the external electronic device 300. Further, the positioning module 223 may store the generated location information of the external electronic device 300 in the original data table.

The positioning module 223 according to another embodiment may acquire information related to the current location of the electronic device 200 on the basis of the information on the external electronic device 300 acquired from the communication module 290. For example, the positioning module 223 may acquire information related to the current location of the electronic device 200 on the basis of the location information of the external electronic device 300 acquired by searching for the acquired identification information of the external electronic device 300 in the geo-fence table. In another example, the positioning module 223 may determine an average value of location information of a plurality of external electronic devices 300 acquired by searching for identification information of the plurality of external electronic devices 200 in the geo-fence table and acquire information related to the current location of the electronic device 200 on the basis of the determined average value. The positioning module 223 may transfer information related to the current location of the electronic device 200 to the geo-fence manager 224, and the geo-fence manager 224 may determine access to the predetermined area (geo-fence) on the basis of the information related to the current location.

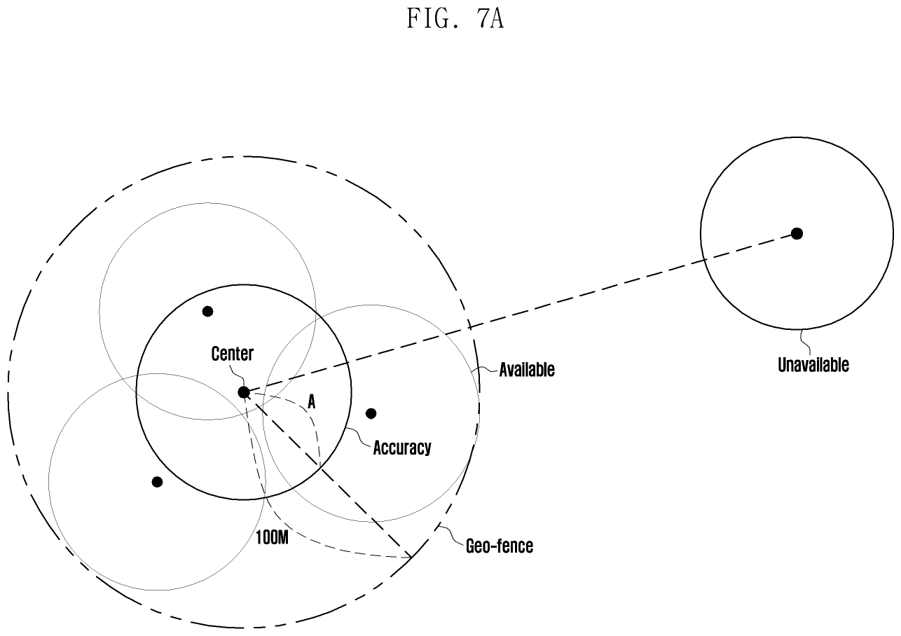

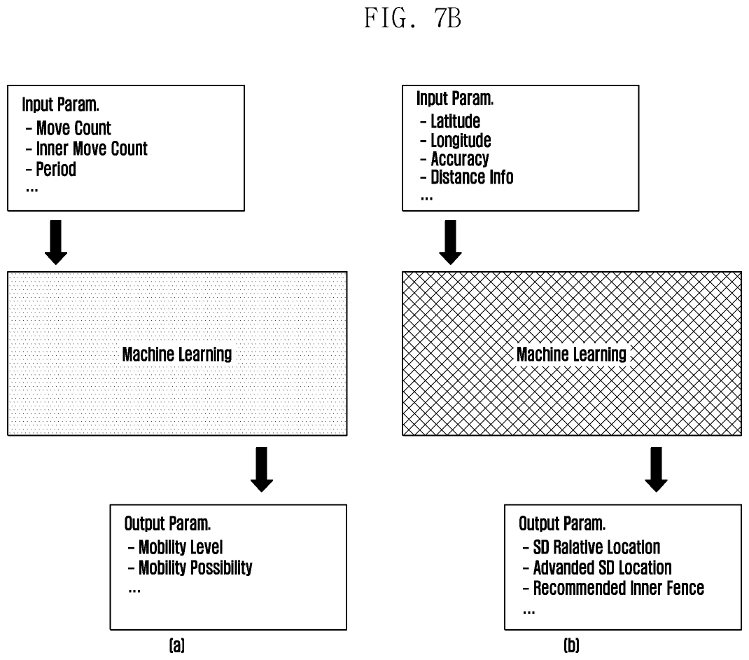

The positioning module 223 according to another embodiment may learn mobility related to the frequency of location movement of the external electronic device 300. For example, the positioning module 223 may input location information of the external electronic device 300 into a learning model and determine mobility of the external electronic device 300. A detailed description related to mobility learning by the positioning module 223 is described with reference to FIG. 7B below.

The geo-fence manager 224 may manage the geo-fence list transmitted through the application 221 and determine access to the predetermined area. For example, the geo-fence manager 224 may generate secondary geo-fence candidates within the primary geo-fence or manage identification information of the external electronic device 300 which can be used for determining access to the geo-fence. For example, the geo-fence manager 224 may collect identification information of the external electronic device 300 and select and/or manage identification information corresponding to the external electronic devices 300 which can be used for determining access to the geo-fence among the collected identification information. For example, the geo-fence manager 224 may transfer identification information of the external electronic device 300 related to the secondary geo-fence candidates to the application 221, acquire the identification information identified by the user from the application 221, and register and manage the corresponding identification information as the secondary geo-fence.

The location validity check module 225 may check validity of location information of the external electronic device 300. For example, the location validity check module 225 may distinguish validity states of the location information of the external electronic device 300 related to whether the location information of the external electronic device 300 can be used for determining the geo-fence. For example, the location validity check module 225 may divide the states into an unknown state in which the location information of the external electronic device 300 is unknown, an available state, and/or an unavailable state according to a predetermined condition.

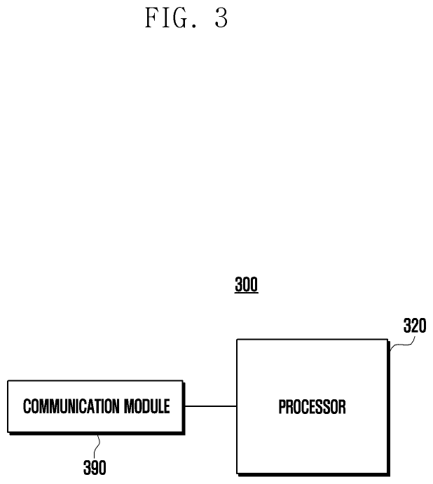

FIG. 3 is a block diagram illustrating the external electronic device 300 according to certain embodiments.

The external electronic device 300 according to certain embodiments may include an Internet of things (IoT) device. For example, the external electronic device 300 may include a smart device having an IoT function (for example, home appliances such as smart TV, air-conditioner, speaker, weight scale, dishwasher, or refrigerator).

Referring to FIG. 3, the external electronic device 300 may include a processor 320 and/or a communication module 390.

According to an embodiment, the communication module 390 may communicate with another electronic device and/or a server through the network and receive and/or transmit various pieces of information. For example, the communication module 390 may receive various requests (for example, a request for transmitting identification information and/or a request for scanning for the external electronic device) through the network (for example, UWB, BT, and/or Wi-Fi) or transmit various pieces of information (for example, identification information and/or location information of the external electronic device) to the electronic device 200. In another example, the communication module 390 may acquire identification information of another external electronic device and/or a relative distance. For example, the communication module 390 may acquire a relative distance to another external electronic device on the basis of a characteristic of a signal exchanged between the external electronic device 300 and another external electronic device (for example, a characteristic of difference between a transmission time and a reception time of the signal or a characteristic related to the magnitude of the signal (received signal received power (RSRP) and/or a received signal strength indicator (RSSI))).

According to an embodiment, the processor 320 may generate a request for various pieces of information acquired from the communication module 390 or process the same. For example, the processor 320 may generate a request for scanning for neighboring external electronic devices through the communication module 390. The processor 320 may transmit location information of another external electronic device related to the acquired identification information of another external electronic device and/or relative distance to the electronic device 200 through the communication module 390.

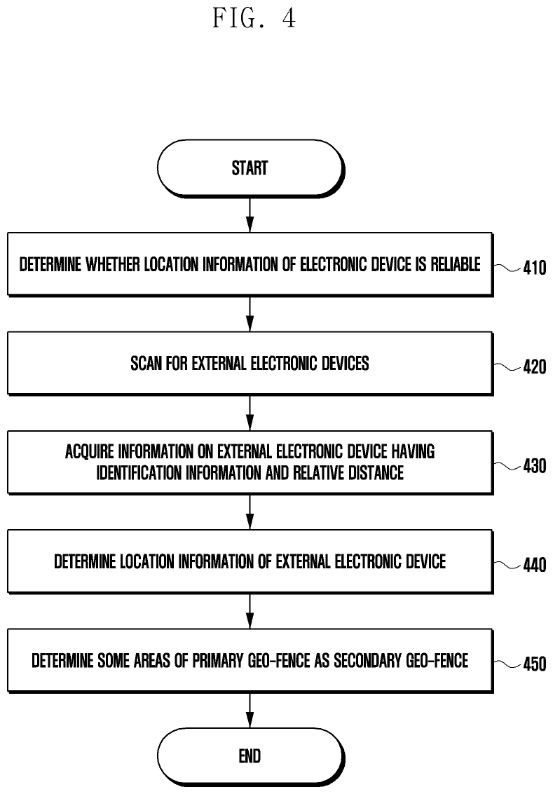

FIG. 4 is a flowchart illustrating a method by which a processor (for example, the processor 220 of FIG. 2) processes location information of an external electronic device (for example, the external electronic device 300 of FIG. 3) according to certain embodiments.

According to certain embodiments, the processor 220 may determine whether location information of an electronic device (for example, the electronic device 200 of FIG. 2) is “reliable” in operation 410.

For example, according to an embodiment, the processor 220 may acquire a present location of the electronic device 200 (e.g., “location information”) from a location sensor (for example, the location sensor 276 of FIG. 2). For example, the processor 220 may acquire GPS information and/or WPS information measured by the location sensor 276.

According to an embodiment, the processor 220 may determine a reliable location radius based on recently determined reliable location information (for example, a position known to be accurate including latitude, longitude coordinates for the same, and accuracy), a movement distance of the electronic device 200, and/or a calibration value. For example, the processor 220 may determine an accuracy radius based on the central point (e.g., as defined by the latitude and longitude) of the recently determined reliable location, the movement distance of the electronic device 200, and/or a reliable location radius obtained by adding the calibration value to the movement distance.

According to an embodiment, the processor 220 may identify the movement distance of the electronic device 200 through a motion sensor (for example, the motion sensor 277 of FIG. 2) capable of measuring the movement of certain activities involving the electronic device 200. For example, the processor 220 may identify the movement distance of the electronic device 200 based on an activity recognition type based on the signal measured by the motion sensor 277 (for example, stationary, walk, run, vehicle, and cycle) and/or a time duration in which the activity was executed. According to an embodiment, the processor 220 may identify levels of the stationary state (for example, arbitrarily named low, mid, and high to represent first, second and third states) when the activity recognition type is recognized as stationary. For example, the lowest level (for example, low or “first”) may indicate a state in which the user is stationary and grips the electronic device 200 and moves their arm, but otherwise remains where they are. The highest level (for example, high or “third”) may be a state in which the electronic device 200 is placed on some surface and then left there by the user.

According to an embodiment, the processor 220 may determine the calibration value based on the activity recognition type and/or the activity duration time. For example, the processor 220 may determine the calibration value to be “0” when the activity recognition type is walking, running, traveling by motorized vehicle, or cycling, and may increase the calibration value as more time lapses while in the stationary state. The processor 220 may omit increase of the calibration value when the device is disposed in the stationary state at the highest level (e.g., for example, high or “third”).

The processor 220 may therefore determine reliability of the location information of the electronic device 200 based on measuring the location information of the electronic device 200. For example, the processor 220 may determine a present detected location of the electronic device 200 includes is reliable location information based on measurement of the location of the electronic device 200 through a location sensor 276 via GPS signal. For example, the processor 220 may determine location information as reliable in accordance when the location information includes WPS information, and the WPS information indicates disposition within the determined reliable location radius.

According to certain embodiments, the processor 220 may scan for the external electronic device (for example, the external electronic device 300 of FIG. 3) in operation 420.

According to an embodiment, the processor 220 may scan for external electronic device(s) 300 through the communication module 290 upon determining that the detected location of the electronic device 200 is satisfies the reliability criteria.

For example, the processor 220 may generate a request for acquiring information on the external electronic device 300 including identification and/or a relative distance to the communication module 290 by scanning for the external electronic device 300 adjacent to the electronic device 200.

According to an embodiment, the processor 220 may generate a request for acquiring location on at least one external electronic device 300 included in the primary geo-fence to the communication module 290.

According to an embodiment, after determining that the location information of the electronic device 200 is reliable (e.g., meeting the reliability threshold), the processor 220 may retrieve information on the external electronic device 300 as acquired by another application, in accordance when a current state/activity of the device is detected as stationary for a threshold time duration.

According to certain embodiments, the processor 220 may acquire information on the external electronic device 300 including the identification information and/or the relative distance in operation 430.

According to an embodiment, the processor 220 may process the information on the external electronic device and add the same to the original data table.

According to an embodiment, the original data table may include location information of the external electronic device including identification information (identification code), latitude, longitude, accuracy, and/or a time stamp of the external electronic device 300. According to an embodiment, the original data table may be stored in a server (for example, the server 108 of FIG. 1) and/or a memory (for example, the memory 230 of FIG. 2).

According to an embodiment, the processor 220 may add location information of the external electronic device 300 based on location information of the electronic device 200 and information on the external electronic device 300 to the original data table. For example, the processor 220 may process identification information of the information on the external electronic device 300 as identification information of the location information of the external electronic device, latitude, longitude, and/or the time stamp as latitude, longitude, and/or the time stamp of the location information of the external electronic device 300, and a value obtained by adding the accuracy of the location information of the electronic device 200 and the relative distance of the information of the external electronic device 300 as the accuracy of the location information of the external electronic device 300 and add the same to the original data table.

According to another embodiment, the processor 220 may add the location information of the electronic device 200 and the location information of the external electronic device based on the location information the external electronic device 300 acquired from the fixed external electronic device to the original data table. For example, among the external electronic devices 300, a fixed external electronic device may periodically scan for neighboring external electronic devices 300 and acquire information on the external electronic device 300 including identification information and/or relatively distance. The processor 220 may add the identification information of the fixed external electronic device and information including the identification information of the external electronic device 300, the relative distance, and/or the time stamp acquired from the fixed external electronic device to the original data table.

According to certain embodiments, the processor 220 may delete some of the information stored in the original data table in accordance with satisfaction of a predetermined condition. For example, when the number of pieces of location information of the external electronic device stored in the original data table is a maximum of the number of pieces of information which can be stored in the original data table, the earliest stored information may be deleted. In another example, when a period during which the location information of the external electronic device is stored in the original data table is longer than or equal to a predetermined period, the processor 220 may delete the corresponding location information of the corresponding external electronic device.

According to an embodiment, the processor 220 may delete information in the location information table and/or the geo-fence table corresponding to the information deleted in the original data table.

According to certain embodiments, the processor 220 may determine location information of the external electronic device 330 in operation 440. For example, the processor 220 may estimate a location of the external electronic device 300 based on the present location of the electronic device 200 and a known relative distance between the electronic device 200 and the external electronic device 300.

According to an embodiment, the processor 220 may process the original data table including the location on the external electronic device 300 to generate a location information table related to the location information of the external electronic device 300.

According to an embodiment, the location information table may include information related to identification information (e.g., identification code (IC)) (e.g., for example, a unique MAC address), latitude, longitude (e.g., defining a current position), accuracy, a valid count, a move count, and/or an inner count.

According to an embodiment, the processor 220 may process information included in the original data table on the basis of the identification information to generate the location information table. For example, the processor 220 may identify an average value of information having the same identification information in the location information of the external electronic device 300 included in the original data table. For example, the processor 220 may determine an average value of the latitude, the longitude, or the accuracy of the location information having the same identification information as latitude, longitude, or accuracy of the location information table.

According to an embodiment, the processor 220 may count a number of times that the detected location (e.g., latitude, longitude, and accuracy) of the external electronic device 300 is found to be within a predetermined range (for example, within a radius of 100 m from the center of the previously acquired location) for the purposes of validity determination. According to an embodiment, when the measured location of the external electronic device 300 is out of the predetermined range, the validity count (e.g., “valid count”) may be set as 1, the location information (e.g., latitude, longitude, and accuracy) of the corresponding identification information may be changed to the location of the external electronic device 300, and the move count may be increased. The processor 220 may determine whether the location of the external electronic device 300, as later acquired, is within the predetermined range from the changed location in accordance with the change in the location of the external electronic device 300.

According to an embodiment, the move count may indicate the number of changes in the location of the external electronic device 300. For example, the move count may be increased when the location of the external electronic device 300 is newly detected as disposed outside the predetermined range from the previously acquired location of the external electronic device 300.

According to an embodiment, the inner move count may be the number of changes in the relative distance in the information on the external electronic device 300 acquired from the fixed external electronic device. That is, the inner move count may indicate a number of movements within a predetermined area (for example, secondary geo-fence area).

According to an embodiment, the period (e.g., days) may be the number of days that have passed from initial collection of the information on the external electronic device 300.

[Table 1] may show an example of the original data table according to an embodiment.

[Table 1] may show an example of the original data table added on the basis of location information of the electronic device 200 collected according to a scenario in which the user of the electronic device 200 remains in an office (for example, location information for an area designated as “office” (37.30342, 127.10214)) from the timespan encompassing 17:56 to 18:12, leaves work at 18:30, enters a mart (for example, location information of the mart (37.28934, 127.07789)) at 19:22, and arrives at home (for example, location information for an area designated as “home” (37.27405, 127.061619)) at 20:38.

TABLE 1

| | | | Accu- | |
|---|---|---|---|---|
| Identification | | | racy | |
| information | Latitude | Longitude | (radius) | Time stamp |
| b8:3a:5a:b5:67:b0 | 37.30342 | 127.10214 | 34M | 2020-11-11 17:56 |
| b8:3a:5a:b5:67:b0 | 37.30342 | 127.10214 | 36M | 2020-11-11 17:56 |
| b8:3a:5a:b5:67:b0 | 37.30342 | 127.10214 | 42M | 2020-11-11 18:12 |
| b8:3a:5a:b5:67:b0 | 37.30342 | 127.10214 | 44M | 2020-11-11 18:12 |
| bc:9f:e4:24:15:d0 | 37.28934 | 127.07789 | 20M | 2020-11-11 19:22 |
| bc:9f:e4:24:15:d0 | 37.28934 | 127.07789 | 23M | 2020-11-11 19:22 |
| 3d:94:52:2e:83:95 | 37.27405 | 127.061619 | 34M | 2020-11-11 20:35 |
| 7b:0d:5e:a2:8c:58 | 37.27405 | 127.061619 | 36M | 2020-11-11 20:35 |
| a4:4c:91:76:38:3b | 37.27405 | 127.061619 | 37M | 2020-11-11 20:35 |
| 33:80:79:3b:bf:50 | 37.27405 | 127.061619 | 37M | 2020-11-11 20:35 |
| fb:7e:9e:f9:ab:24 | 37.27405 | 127.061619 | 36M | 2020-11-11 20:35 |
| 3d:94:52:2e:83:95 | 37.27405 | 127.061619 | 21M | 2020-11-11 20:47 |
| 7b:0d:5e:a2:8c:58 | 37.27405 | 127.061619 | 23M | 2020-11-11 20:47 |
| a4:4c:91:76:38:3b | 37.27405 | 127.061619 | 24M | 2020-11-11 20:47 |
| 33:80:79:3b:bf:50 | 37.27405 | 127.061619 | 24M | 2020-11-11 20:47 |
| 3d:94:52:2e:83:95 | 37.27405 | 127.061619 | 25M | 2020-11-11 21:06 |
| 7b:0d:5e:a2:8c:58 | 37.27405 | 127.061619 | 27M | 2020-11-11 21:06 |
| a4:4c:91:76:38:3b | 37.27405 | 127.061619 | 26M | 2020-11-11 21:06 |
| 33:80:79:3b:bf:50 | 37.27405 | 127.061619 | 26M | 2020-11-11 21:06 |
| 3d:94:52:2e:83:95 | 37.27405 | 127.061619 | 19M | 2020-11-11 21:51 |

The processor 220 according to an embodiment may process data based on identification information in [Table 1] to generate a location information table as shown in [Table 2], below.

TABLE 2

| Identification | | | Accuracy | Valid | Move | Inner move | Period |
|---|---|---|---|---|---|---|---|
| information | Latitude | Longitude | (radius) | count | count | count | (days) |
| 7b:0d:5e:a2:8c:58 | 37.27405 | 127.061619 | 28.23M | 56 | 0 | 0 | 7 |
| b8:3a:5a:b5:67:b0 | 37.30342 | 127.10214 | 40.3M | 4 | 2 | 0 | 7 |
| bc:9f:e4:24:15:d0 | 37.28934 | 127.07789 | 23.5M | 7 | 0 | 0 | 4 |
| fb:7e:9e:f9:ab:24 | 37.27405 | 127.061619 | 36M | 2 | 0 | 0 | 1 |
| bc:9f:e4:23:27:90 | 37.27405 | 127.061619 | 20.8M | 32 | 0 | 0 | 7 |
| 3d:94:52:2e:83:95 | 37.27405 | 127.061619 | 29.17M | 4 | 17 | 0 | 6 |
| a4:4c:91:76:38:3b | 37.27405 | 127.061619 | 29.23M | 60 | 0 | 0 | 7 |
| 33:80:79:3b:bf:50 | 37.27405 | 127.061619 | 29.23M | 60 | 0 | 0 | 7 |

The processor 220 may determine an average value of latitude, longitude, and accuracy having the same identification information in the original data table of [Table 1], as latitude, longitude, and accuracy of the location information table of [Table 2]. Further, the processor 220 may determine the number of times the location (e.g., latitude, longitude, and accuracy) of the external electronic device 300 is measured to be within a predetermined range (e.g., for example, within 100 m from the previously acquired location of the external electronic device 300), as the valid count in the original data table of [Table 1]. For example, in the case of the external electronic device having identification information of 7b: 0d:5e: a2:8c:58 in the location information table of [Table 2], the location may be measured for 7 days, the average latitude measured within a predetermined range 56 times may be 37.27405, the longitude may be 127.061619, and the accuracy may be 28.23 M. Since a relative low average move count and no inner move count, it may indicate that the corresponding external electronic device has limited or no movement outside the predetermined range and/or inside the predetermined area.

For example, in the case of the external electronic device having identification information of b8:3a:5a:b5:67:b0 in the location information table of [Table 2], the location is measured for 7 days, and the move count is measured as 2 times, and thus, it may indicate that the external electronic device moved outside the predetermined range for 7 days 2 times. Accordingly, the latitude 37.30342, the longitude 127.10214, and the accuracy 40.3 M may indicate the average of the changed location after movement to the outside of the predetermined range, and a value of 3 for the validity count may indicate three 3 detections of the external device being within the predetermined range from the center of the changed location.

According to certain embodiments, the processor 220 may set at least a partial area of the primary geo-fence to be a secondary geo-fence in operation 450.

According to an embodiment, the processor 220 may execute learning on the location information table to generate a geo-fence table related to the primary geo-fence and/or the secondary geo-fence.

According to certain embodiments, the geo-fence table may include identification information of the external electronic device, a geo-fence ID, a validity state, and/or information related to user identification.

According to an embodiment, the geo-fence ID is a name defining a predetermined area and may mean a name of the primary geo-fence and/or the secondary geo-fence which the application 221 identifies from the user. According to an embodiment, the validity state may include an index indicating whether the external electronic device corresponding to the identification information can be used for geo-fence determination, and the information related to the user identification may include an index indicating whether the geo-fence is a geo-fence which the application identifies from the user.

According to an embodiment, the processor 220 may identify the validity state of the location information related to whether the location information of the external electronic device 300 can be used for g-fence determination. For example, the processor 220 may determine the location information of the external electronic device 300 to indicate one of predefined validity states, including an “unknown state,” an “available” state, and/or an “unavailable” state.

According to an embodiment, the “unknown” state indicates that the location information of the external electronic device 300 not adequately detected, cannot be determined with respect to some threshold, and/or has not been adequately processed by machine-learning (or insufficient for such processing), and thus, it is not possible at present to determine whether the location information can be used for geo-fence determination. According to an embodiment, the validity state of the location information of the external electronic device 300 that was first measured may be configured as the unknown state.

According to an embodiment, the “available” state indicate that the location information of the external electronic device 300 is sufficiently detected, passes some threshold, and/or is sufficiently processed by machine-learning, and so it is determined that the location information can be used for geo-fence determination. For example., when the validity count of specific identification information is larger than or equal to a predetermined number and the period longer than or equal to a predetermined time in the location information table, the processor 220 according to an embodiment may set the validity state of the corresponding identification information in the geo-fence table to be the “available” state. For example, a location of the device is detected a predetermined number of times (for example, 20 times) or more to be within a predetermined range for a predetermined time (for example, 72 hours or longer), the processor 220 may set the validity state of the corresponding external electronic device 300 as the “available” state. Further, the processor 220 may maintain the available state while the location of the external electronic device 300 remains within a predetermined range (for example, radius of 100 m) from the existing location.

According to another embodiment, in the case of the geo-fence configured by the user through an application (for example, the application 221 of FIG. 2), the validity state may be configured as the “available” state and the user identification may be configured as “0”. For example, the processor 220 may classify the location information of the corresponding external electronic device 300 as the available state in accordance with identification information of the external electronic device 300 corresponding to identification information registered as the geo-fence in the application 221. When the location information of the external electronic device 300 is in the available state, the processor 220 may use the location information of the corresponding external electronic device 300 to determine whether the location information is within the predetermined area (geo-fence determination).

The “unavailable” state may be a state in which the location is changed in the available state and additional information and/or machine learning is should be executed. For example, when the location of the external electronic device 300 is detected to be outside the radius of the predetermined range from the existing location, the processor 220 may set the unavailable state. According to an embodiment, as the location information of the external electronic device 300 corresponding to the identification information is in the available state and then the location information of the external electronic device escapes the predetermined rate and thus the move count increases, the processor 220 may configure the state as the unavailable state.

According to an embodiment, when the location information of the external electronic device 300 is in the unavailable state, the processor 220 may not use the location information for geo-fence determination.

[Table 3] below may show an example of the geo-fence table according to an embodiment.

TABLE 3

| Identification | | | User |
|---|---|---|---|
| information | Geo-fence ID | Validity state | identification |
| 7b:0d:5e:a2:8c:58 | Home-living room | Available | ◯ |
| b8:3a:5a:b5:67:b0 | Office | Unavailable | X |
| bc:9f:e4:24:15:d0 | Mart | Unknown | X |
| fb:7e:9e:f9:ab:24 | Home | Unknown | X |
| bc:9f:e4:23:27:90 | Home-main room | Available | ◯ |
| 3d:94:52:2e:83:95 | Home | Unavailable | X |
| a4:4c:91:76:38:3b | Home-living room | Available | X |
| 33:80:79:3b:bf:50 | Home-living room | Available | X |

Referring to the geo-fence table of [Table 3], the external electronic device having identification information of 7b:0d:5e:a2:8c:58 may be a geo-fence configured by the user through the application 221, and the processor 220 may use location information of the corresponding external electronic device for geo-fence determination. For example, the external electronic device is located in the living room and has the validity state corresponding available, so that the processor 220 may use the location information to determine whether the electronic device 200 enters the living room area. The external electronic device having identification information of a4:4c:91:76:38:3b may be configured in the available state since the location is measured in the “home-living room” area for a predetermined time or longer a predetermined number of times or more. Accordingly, the processor 220 may use the location information of the external electronic device having identification information of a4:4c:91:76:38:3b for geo-fence determination. On the other hand, in the case of the external electronic device having identification information of fb:7e:9e:f9:ab:24, the location information of the external electronic device is not sufficiently learned and thus the processor 220 cannot use the location information of the corresponding external electronic device for geo-fence determination. Further, the external electronic device having identification information of b8:3a:5a:b5:67:b0 learns location information in a predetermined area (office) and thus is in the available state, and then moves from a place out of a range of the predetermined area (office) to the predetermined area (office) again during learning and thus is learning, and accordingly, the move count from the existing location is two and the learning count is not sufficient. As a result, the identification information is in the unavailable state for geo-fence determination.

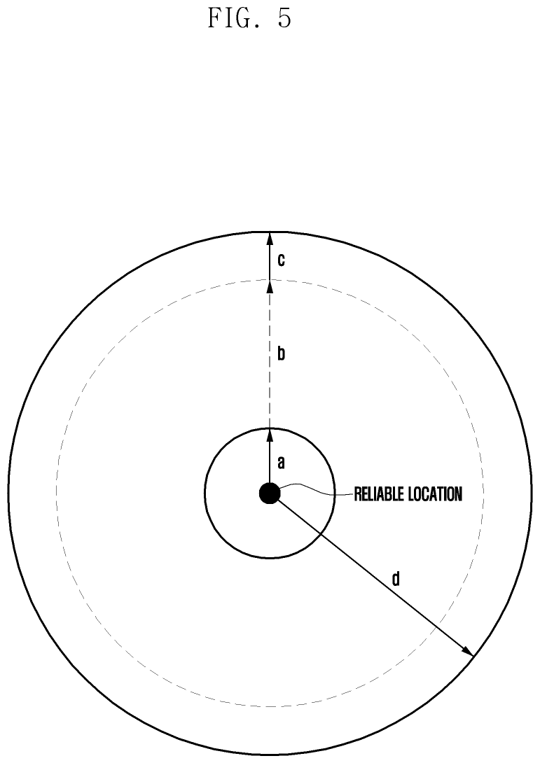

FIG. 5 illustrates an operation in which a processor (for example, the processor 220 of FIG. 2) determines a reliable location radius in order to determine whether the location of an electronic device (for example, the electronic device 200 of FIG. 2) is reliable according to certain embodiments.

FIG. 5 may be an example for describing some operations of operation 410 in FIG. 4.

According to an embodiment, the processor 220 may acquire the location of the electronic device 200 from a location sensor (for example, the location sensor 276 of FIG. 2). For example, the processor 220 may acquire GPS information and/or WPS information of the electronic device 200 measured by the location sensor 276.

According to an embodiment, the processor 220 may determine a reliable location radius (d) to determine whether the location of the electronic device 200 is reliable. For example, the processor 220 may determine the reliable location radius (d) based on the recently determined reliable location (for example, latitude and longitude) of the electronic device 200, a semidiameter (a) of the accuracy circle, a movement distance (b) of the electronic device 200, and/or a calibration value (c). The reliable location circle (d) may be a circle, as a semidiameter, having a value obtained by adding the semidiameter (a) of the accuracy circle from the center of the reliable location of the electronic device 200, the movement distance (b), and/or the calibration value (c).

For example, the accuracy circle may be a probability circle in which the real location of a circle having, as a semidiameter, an accuracy (a) value from the reliable location (for example, latitude and longitude) may exist.

The processor 220 may identify the movement distance (b) of the electronic device 200 through the motion sensor 277 capable of measuring activities. For example, the processor 220 may identify the movement distance (b) of the electronic device 200 on the basis of an activity recognition type (for example, stationary, walk, run, vehicle, and cycle) based on a signal measured by the motion sensor 227 and a duration time. Further, the processor 220 according to an embodiment may divide levels (for example, low, mid, and high) in the stationary state of the activity recognition type. For example, the lowest level (for example, low) in the stationary state may be a state in which the user grips the electronic device 200 and is located at one position, and the highest level (for example, high) may be a state in which the electronic device 200 is put on one position.

The processor 220 may determine the calibration value (c) on the basis of the activity recognition type and the duration time. For example, the processor 220 may determine the calibration value (c) as 0 in the state in which the activity recognition type is walk, run, vehicle, or cycle and may increase the calibration value (c) according to an increase in the duration time in the stationary state. Further, the processor 220 may not increase the calibration value (c) in the highest stationary state (for example, high).

According to an embodiment, the processor 220 may determine the reliable location as the acquired location (for example, WPS) of the electronic device 200 is within the determined reliable location radius (d).

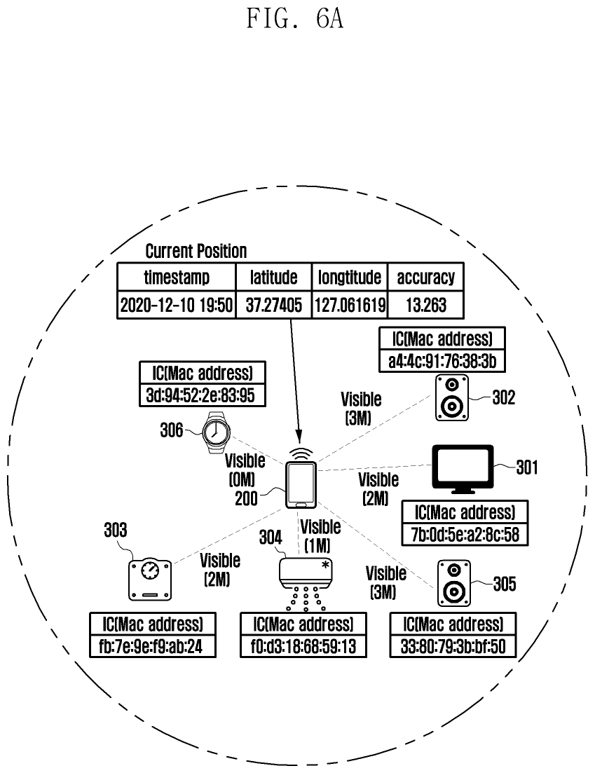

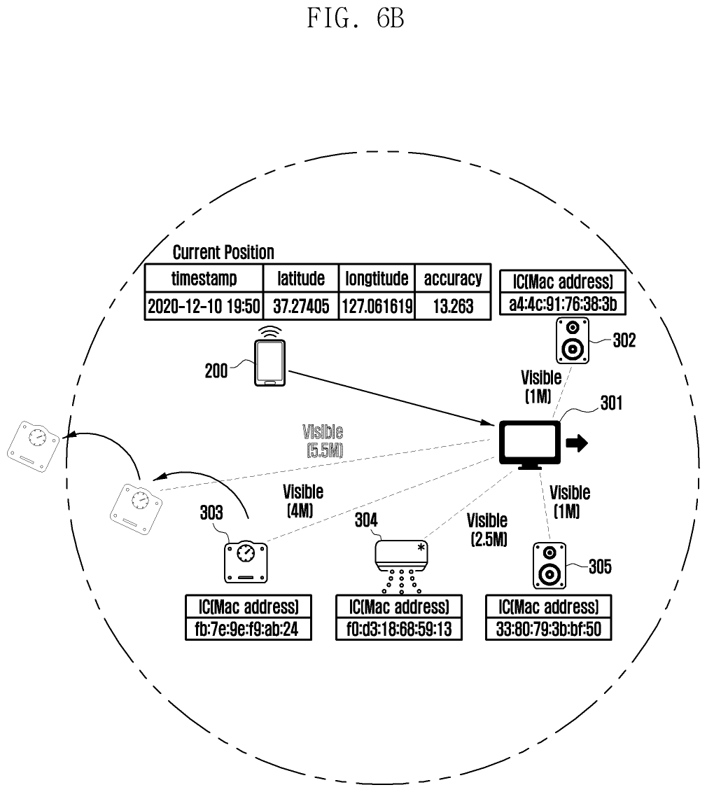

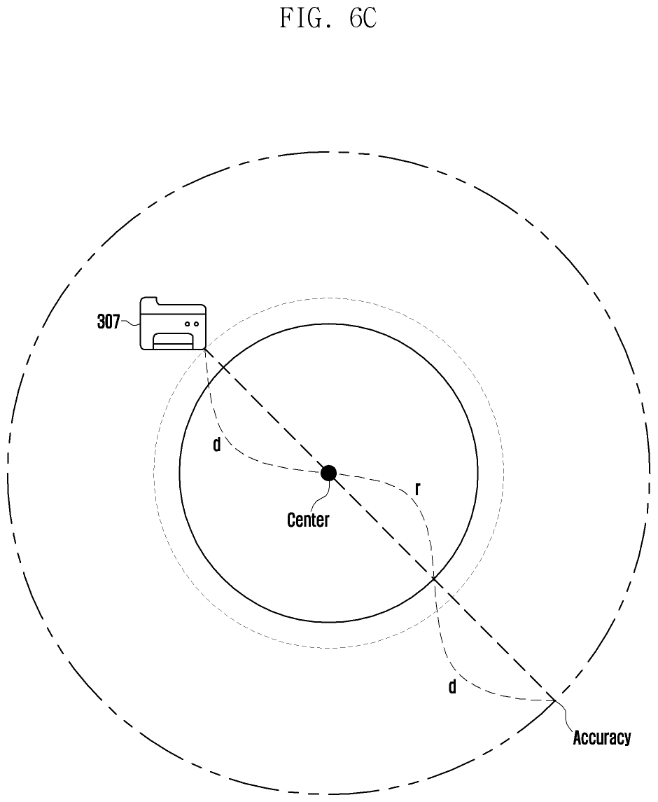

FIG. 6A illustrates an operation in which a processor (for example, the processor 220 of FIG. 2) scans for external electronic devices (for example, external electronic device 300 of FIG. 3) according to certain embodiments.

FIG. 6A illustrates an example of some operations of operation 420 and/or operation 430 in FIG. 4.

According to an embodiment, location information of the electronic device 200 (latitude: 37.27405, longitude: 127.061619, and accuracy value (e.g., a radius of a circle): 13.263) determined to be “reliable.”

According to an embodiment, as the location information of the electronic device 200 is determined as reliable, the processor 220 may scan for external electronic devices 301, 302, 303, 304, 305, and 306 through the communication module 290. For example, the processor 220 may scan for external electronic devices 300 disposed proximate to the electronic device 200, and generate a request for acquiring information on the external electronic devices 301, 302, 303, 304, 305, and 306 including identification information and/or relative distances to the communication module 290.

For example, the processor 220 may acquire identification information (7b:0d:5e:a2:8c:58) and a relative distance (2 M) of the first external electronic device 301, identification information (a4:4c:91:76:38:3b) and a relative distance (3 M) of the second external electronic device 302, identification information (fb:7e:9e:f9:ab:24) and a relative distance (2 M) of the third external electronic device 303, identification information (f0:d3:18:68:59:13) and a relative distance (1M) of the fourth electronic device 304, identification information (33:80:79:3b:bf:50) and a relative distance (3 M) of the fifth electronic device 305, and/or identification information (3d:94:52:2e:83:95) and a relative distance (0 M) of the sixth electronic device 306.

According to an embodiment, the processor 220 may add location information of the electronic device 200 and location information of the external electronic devices 301, 302, 303, 304, 305, and 306 based on information on the external electronic devices 301, 302, 303, 304, 305, and 306 in an original data table.

For example, the processor 220 may add data of identification information of the information on each of the external electronic devices 301, 302, 303, 304, 305, and 306 as identification information of the locations of each the external electronic devices 301, 302, 303, 304, 305, and 306, latitude, longitude, and/or time stamp of the location information of the electronic device 200 as latitude, longitude, and/or time stamp of the location information of each of the external electronic devices 301, 302, 303, 304, 305, and 306, and a value obtained by adding the accuracy value of the location information of the electronic device 200 and the relative distances of each of the external electronic devices 301, 302, 303, 304, 305, and 306 as accuracy values of each the external electronic devices 301, 302, 303, 304, 305, and 306, to the original data table.

[Table 4] below may show location information of the external electronic devices 301, 302, 303, 304, 305, and 306 stored by the processor 220 in the original data table.

TABLE 4

| | | | Accu- | |
|---|---|---|---|---|
| Identification | | | racy | |
| information | Latitude | Longitude | (radius) | Time stamp |
| 7b:0d:5e:a2:8c:58 | 37.27405 | 127.061619 | 15.263 | 2020-12-10 19:50 |
| a4:4c:91:76:38:3b | 37.27405 | 127.061619 | 16.263 | 2020-12-10 19:50 |
| fb:7e:9e:f9:ab:24 | 37.27405 | 127.061619 | 15.263 | 2020-12-10 19:50 |
| f0:d3:18:68:59:13 | 37.27405 | 127.061619 | 14.263 | 2020-12-10 19:50 |
| 33:80:79:3b:bf:50 | 37.27405 | 127.061619 | 16.263 | 2020-12-10 19:50 |
| 3d:94:52:2e:83:95 | 37.27405 | 127.061619 | 13.263 | 2020-12-10 19:50 |

According to [Table 4] above, the processor 220 may add identification information of the external electronic devices 301, 302, 303, 304, 305, and 306, latitude (37.27405), longitude (127.061619), and the time stamp (2020-12-10 19:50) in the location information of the electronic device 200, and accuracy of the external electronic devices 301, 302, 303, 304, 305, and 306 obtained by adding the accuracy value (13.263) of the electronic device 200 to relative distances of the respective external electronic devices (2 M, 3 M, 2 M, 1 M, 3 M, and 0 M) as set forth in the original data table. FIG. 6B illustrates an operation in which a fixed external electronic device scans for an external electronic device (for example, external electronic device 300 of FIG. 3) according to certain embodiments.

FIG. 6 illustrates an example for describing some operations of operation 420 and/or operation 430 in FIG. 4.

According to an embodiment, the processor 220 may add information on the external electronic device 300 acquired from the fixed first external electronic device 301 and identification information of the fixed first external electronic device 301 to a distance original data table. For example, among the external electronic devices 301, 302, 303, 304, and 605, the fixed first external electronic device 301 may periodically scan for neighboring external electronic devices 302, 303, 304, and 305 to acquire information on the external electronic devices 302, 303, 304, and 305 including identification information and/or relative distances. For example, the fixed first external electronic device 301 may acquire identification information (a4:4c:91:76:38:3b) and the relative distance (1 M) of the second external electronic device 302, identification information (fb:7e:9e:f9:ab:24) and the relative distance (4 M) of the third external electronic device 303, identification information (f0:d3:18:68:59:13) and the relative distance (2.5 M) of the fourth external electronic device 304, and/or information (33:80:79:3b:bf:50) and the relative distance (1 M) of the fifth external electronic device 305.

[Table 5] below may show information on the external electronic devices 302, 303, 304, and 305 acquired through scanning for the external electronic devices 302, 303, 304, and 305 by the fixed first external electronic device 301.

TABLE 5

| Identification | Relative | |
|---|---|---|
| information | distance | Time stamp |
| a4:4c:91:76:38:3b | 1M | 2020-11-11 19:06 |
| fb:7e:9e:f9:ab:24 | 4M | 2020-11-11 19:06 |
| f0:d3:18:68:59:13 | 2.5M | 2020-11-11 19:06 |
| 33:80:79:3b:bf:50 | 1M | 2020-11-11 19:06 |
| a4:4c:91:76:38:3b | 1M | 2020-11-11 20:06 |
| fb:7e:9e:f9:ab:24 | 5.5M | 2020-11-11 20:06 |
| f0:d3:18:68:59:13 | 2.5M | 2020-11-11 20:06 |
| 33:80:79:3b:bf:50 | 1M | 2020-11-11 20:06 |
| a4:4c:91:76:38:3b | 1M | 2020-11-11 21:06 |
| f0:d3:18:68:59:13 | 2.5M | 2020-11-11 21:06 |
| 33:80:79:3b:bf:50 | 1M | 2020-11-11 21:06 |

According to [Table 5] above, the fixed first external electronic device 301 may scan for and collect information on the neighboring external electronic devices 302, 303, 304, and 305 periodically (e.g., hourly). Referring to [Table 5], the relative distance of the third external electronic device 303 (identification information: fb:7e:9e:f9:ab:24) is 4 M at 2020-11-11 19:06, may be changed to 5.5 M at 2020-11-11 at 20:06, and detection of the same ceases on 2020-11-11 at 21:06. In other words, it may indicate that the third external electronic device 303 has moved out of a detection range of the first external electronic device 301 at 2020-11-11 as 21:06, and thus, the first external electronic device 301 cannot acquire information on the third external electronic device 303.

TABLE 6

| Identification | Identification | Relative | |
|---|---|---|---|
| information | information | distance | Time stamp |
| 7b:0d:5e:a2:8c:58 | a4:4c:91:76:38:3b | 1M | 2020-11-11 19:06 |
| 7b:0d:5e:a2:8c:58 | fb:7e:9e:f9:ab:24 | 4M | 2020-11-11 19:06 |
| 7b:0d:5e:a2:8c:58 | f0:d3:18:68:59:13 | 2.5M | 2020-11-11 19:06 |
| 7b:0d:5e:a2:8c:58 | 33:80:79:3b:bf:50 | 1M | 2020-11-11 19:06 |
| 7b:0d:5e:a2:8c:58 | a4:4c:91:76:38:3b | 1M | 2020-11-11 20:06 |
| 7b:0d:5e:a2:8c:58 | fb:7e:9e:f9:ab:24 | 5.5M | 2020-11-11 20:06 |
| 7b:0d:5e:a2:8c:58 | f0:d3:18:68:59:13 | 2.5M | 2020-11-11 20:06 |
| 7b:0d:5e:a2:8c:58 | 33:80:79:3b:bf:50 | 1M | 2020-11-11 20:06 |
| 7b:0d:5e:a2:8c:58 | a4:4c:91:76:38:3b | 1M | 2020-11-11 21:06 |
| 7b:0d:5e:a2:8c:58 | f0:d3:18:68:59:13 | 2.5M | 2020-11-11 21:06 |
| 7b:0d:5e:a2:8c:58 | 33:80:79:3b:bf:50 | 1M | 2020-11-11 21:06 |

[Table 6] may be an example of the distance original data table generated based on another external electronic device acquired by the fixed first external electronic device 301. Referring to [Table 6], the processor 220 may add identification information of the fixed first external electronic device 301 to the information on the external electronic device, as acquired from the fixed first external electronic device 301, so as to generate the distance original data table.

TABLE 7

| Fixed external electronic | | | Total | |
|---|---|---|---|---|
| device identification | Identification | Relative | num- | Period |
| information | information | distance | ber | (days) |
| 7b:0d:5e:a2:8c:58 | a4:4c:91:76:38:3b | 1M | 4 | 1 |
| 7b:0d:5e:a2:8c:58 | fb:7e:9e:f9:ab:24 | 4.75M | 2 | 1 |
| 7b:0d:5e:a2:8c:58 | f0:d3:18:68:59:13 | 2.5M | 4 | 1 |
| 7b:0d:5e:a2:8c:58 | 33:80:79:3b:bf:50 | 1M | 4 | 1 |

[Table 7] may be an example of the distance information table generated on the basis of the distance original data table. Referring to [Table 7], the processor 220 may generate the distance information table based on the distance information table of [Table 6]. For example, the processor 220 may determine an average value of relative distances of identification information in the distance original data table of [Table 6] as relative distances of the distance information table of [Table 7]. Further, the processor 220 may identify the number of times the external electronic device measures information on the same identification information in the distance original data table of [Table 6] and determine the same as the total number in [Table 7]. For example, in the case of the second external electronic device 302 (identification information: a4:4c:91:76:38:3b) in the distance information table of [Table 7], the location may be measured for 1 day and the relative distance to the fixed first external electronic device 301 averagely measured 4 times may be 1 M.

The processor 220 according to certain embodiments may generate a location information table on the basis of the distance information table according to operation 440 of FIG. 4.

FIG. 6C illustrates an operation in which the processor 220 determines accuracy of the external electronic device 300 according to certain embodiments of the disclosure.

FIG. 6C illustrates an example for describing some operations of operation 430 in FIG. 4.

According to an embodiment, location information of the electronic device 200 may include a location (e.g., defining a center point based on latitude and longitude), accuracy value (e.g., defining a radius), and/or a time stamp. According to an embodiment, information on the external electronic device 307 may include identification information and/or a relative distance (e.g., d). According to an embodiment, location information of the external electronic device 307 may include identification information, latitude, longitude, accuracy, and/or a time stamp.

FIG. 6C illustrates an operation in which the processor 220 determinates an accuracy of an estimated location of the external electronic device 307. An accuracy circle of the location information of the external electronic device 307 may define a probability radius of a circle having, as a radius, the accuracy value from the center point location defined by the known latitude and longitude, in which the external electronic device 307 is disposed. A latitude and longitude of the external electronic device 307 are values defining the location center of the location of the electronic device 200, and may be known to be a reliable location determination, as per operation 410 of FIG. 4. An accuracy value (e.g., radius) for the location of the external electronic device 307 may be generated by adding together the accuracy value (e.g., the radius) of the electronic device 200 and the relative distance (d) for the external electronic device 307.

FIG. 7A illustrates an operation in which a processor (for example, the processor 220 of FIG. 2) determines a validity state according to certain embodiments.

According to an embodiment, the processor 220 may identify the validity state of the location information related to whether the location information of the external electronic device 300 can be used for g-fence determination. For example, the processor 220 may divide the location information into an unknown state, an available state, and/or an unavailable state.

Referring to FIG. 7A, as the location of the external electronic device 300 is detected to be within a predetermined range (geo-fence) (for example, within about 100 m from the location center) for a predetermined period of time, and/or for a predetermined number of times or more, the processor 220 may set the location information of the corresponding external electronic device 300 to be the available state.

On the other hand, when the location of the external electronic device 300 is detected outside the radius of the predetermined range (geo-fence) from the existing location, the processor 220 may set the unavailable state.

FIG. 7B illustrates an operation in which the processor 220 learns information through machine learning according to certain embodiments of the disclosure.

FIG. 7B illustrates an example for describing some operations of operation 450 in FIG. 4.

Referring to FIG. 7B(a), the processor 220 according to certain embodiments may input a move count, an inner move count, and a period into a learned model and determine mobility of each of the external electronic devices 300. For example, the processor 220 may calculate a mobility possibility of the external electronic device 300 and determine a mobility level (for example, level 0, 1, or 2) based on the mobility possibility. According to an embodiment, mobility level 0 may indicate no movement and level 2 may mean a higher predefined tier of movement.

According to certain embodiments, the processor 220 may use the mobility level as one of the elements for determining a validity state of the external electronic device. For example, when determining that the external electronic device has a mobility level of 0 corresponding to the unavailable state, the processor 220 may determine the validity state multiple times without immediately setting the unavailable state. When the unavailable state is determined, the processor 220 may configure the validity state of the corresponding external electronic device to be the unavailable state . For example, the processor 220 may set the validity state of an external electronic device having a mobility level of 0 as the unavailable state and omits the external electronic device from geo-fence determination, and stores relevant information indicating omission of the corresponding external electronic device for later geo-fence determination.

Referring to FIG. 7B(b), the processor 220 according to certain embodiments may input location information (latitude, longitude, and accuracy) of the external electronic device 300 and distance information (distance info) between the external electronic device 300 and another external electronic device into a learned model to acquire a relative distance (e.g., relative location) between the external electronic devices 300. Further, the processor 220 according to certain embodiments may acquire precise location information (e.g., advanced location) of the external electronic device 300 on the basis of the relative location. The processor 220 according to certain embodiments may estimate a secondary geo-fence (inner fence) on the basis of the precise location information (advanced location) and provide recommendation of the secondary geo-fence to the user through the application 221.

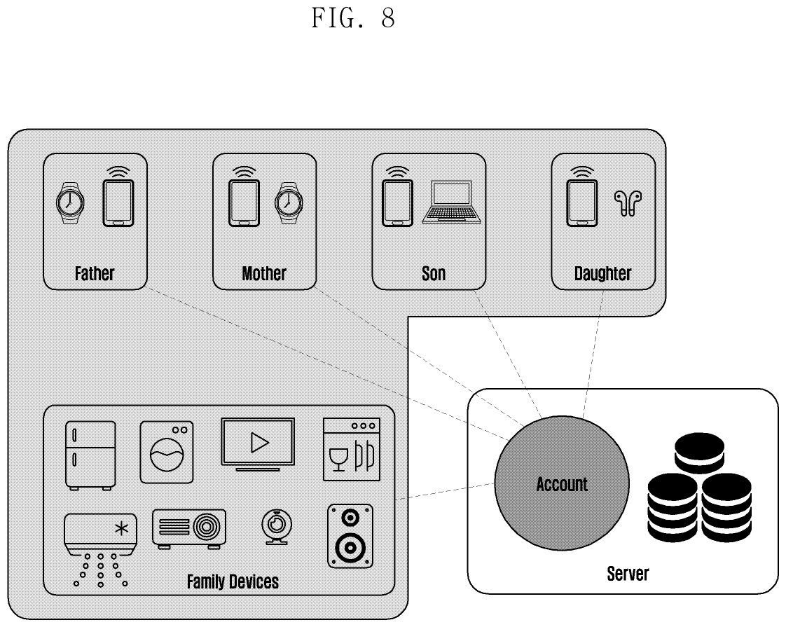

FIG. 8 illustrates an operation of a server (for example, the server 108 of FIG. 1) according to certain embodiments.

According to the embodiments of FIG. 8, a first user (father), a second user (mother), a third user (son), and a fourth user (daughter) may share an account related to a predetermined area (for example, a home). The shared account may be managed by the server 108. The server 108 may store a geo-fence table based on information related to external electronic devices (family devices) in a geo-fence table, and the electronic device belonging to each user may determine a geo-fence by using the geo-fence table stored in the server through the authenticated account and update the geo-fence table. For example, when geo-fence information is changed by learning of each user in the electronic device or by user settings, the changed information may be synchronized with the electronic device linked to the account.

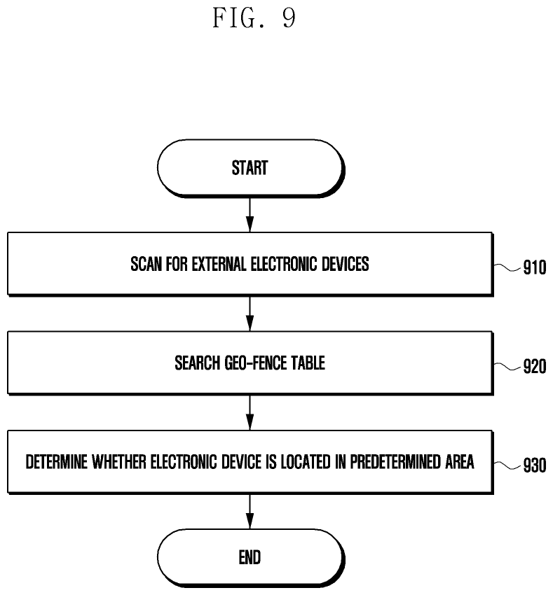

FIG. 9 is a flowchart illustrating a method by which a processor (for example, the processor 220 of FIG. 2) scans for external electronic devices (for example, the external electronic devices 300 of FIG. 3) and determines whether the external electronic devices are located in a predetermined area according to certain embodiments.

According to certain embodiments, the processor 220 may scan for the external electronic devices 300 in operation 910.

According to an embodiment, the processor 220 may scan for the external electronic devices 300 through the communication module 290. For example, the processor 220 may scan for external electronic devices 300 adjacent to the electronic device 200 and generate a request for acquiring identification information of the external electronic device 300 to the communication module 290.

According to certain embodiments, the processor 220 may search the geo-fence table in operation 920.

According to certain embodiments, the geo-fence table may include identification information of the external electronic device, a geo-fence ID, a valid state, and/or information related to user identification. According to an embodiment, the geo-fence ID is a name defining a predetermined area and may be a name of a primary geo-fence and/or a secondary geo-fence which the application identifies from the user. According to an embodiment, the valid state may include an index indicating whether the external electronic device corresponding to the identification information can be used for geo-fence determination, and the information related to the user identification may include an index indicating whether the geo-fence is a geo-fence which the application identifies from the user. According to certain embodiments, the geo-fence table may be stored in a server (for example, the server 108 of FIG. 1) and/or a memory (for example, the memory 230 of FIG. 2).

According to an embodiment, the processor 220 may search for corresponding identification information in the geo-fence table on the basis of acquired identification information of the external electronic device 300.

According to an embodiment, as the acquired identification information of the external electronic device 300 exists in the geo-fence table, the processor 220 may identify whether the validity state of the corresponding identification information is an available state and use the identification information for geo-fence determination. For example, the corresponding identification information may be used for geo-fence determination as the validity state of the corresponding identification information is the available state, and the corresponding identification information may not be used for geo-fence determination as the validity state is the unavailable state and/or the unknown state.

According to certain embodiments, the processor 220 may determine whether the electronic device 200 is located in the predetermined area in operation 930.

According to an embodiment, as the acquired identification information of the external electronic device 300 has available validity state in the geo-fence table, the processor 220 may search a geo-fence ID and determine whether it is located in the predetermined area. For example, the processor 220 may identify a geo-fence ID corresponding to the acquired identification information and determine that the electronic device 200 is located in a predetermined area corresponding to the geo-fence ID.

According to an embodiment, as it is determined whether the electronic device 200 is located in the predetermined area, the processor 220 may transfer information related to access to the geo-fence to the application 221.

According to an embodiment, as the acquired identification information of the external electronic device 300 is in the unavailable state and/or the unknown validity state in the geo-fence table and/or there is no identification information corresponding to the geo-fence table, the processor 220 may learn and process location information of the external electronic device to update the geo-fence table in operations 410 to 450 of FIG. 4.

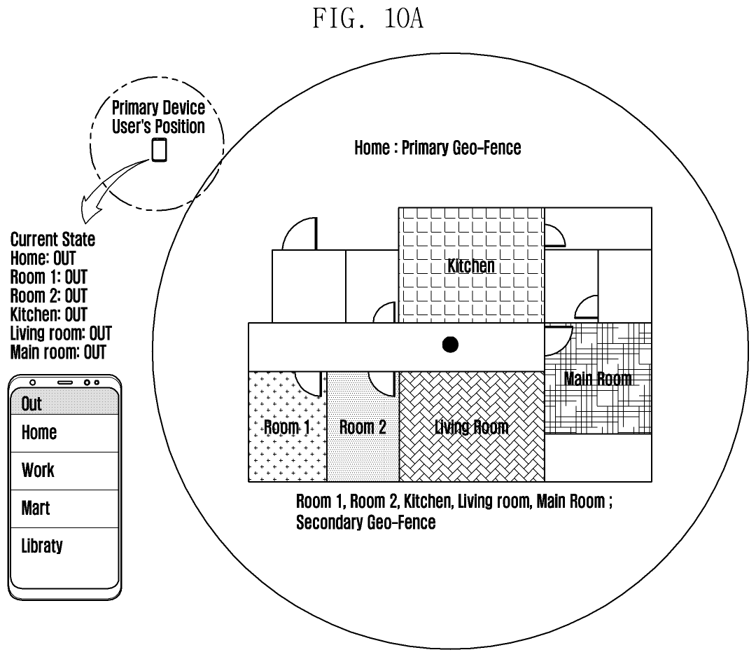

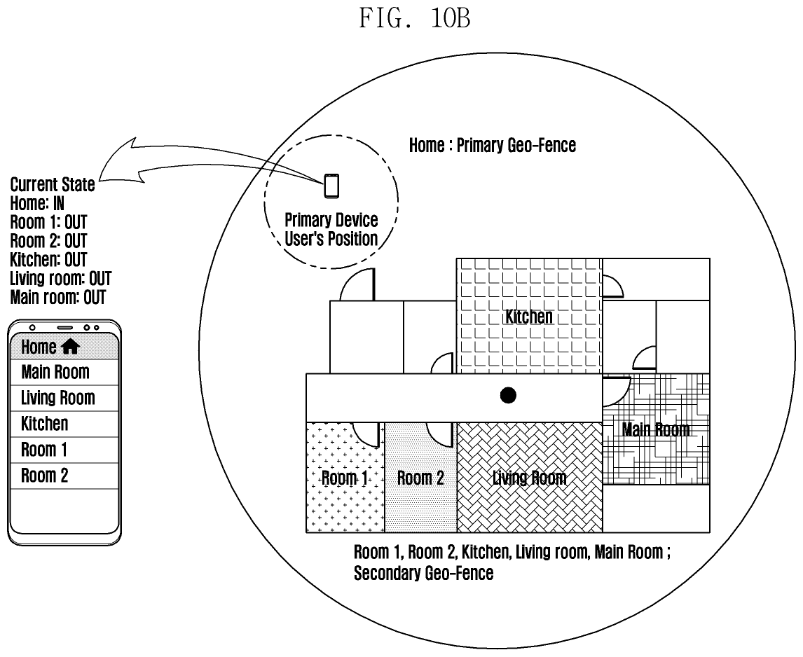

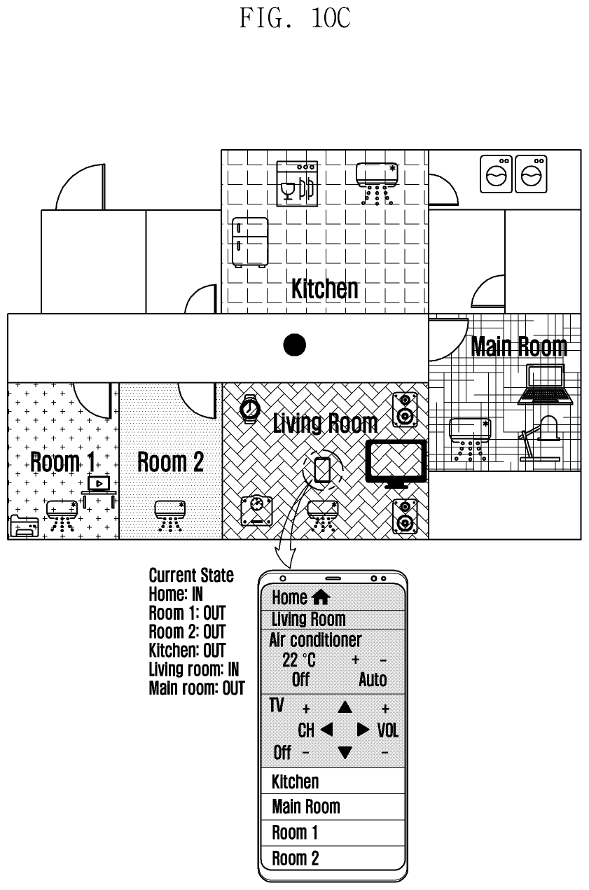

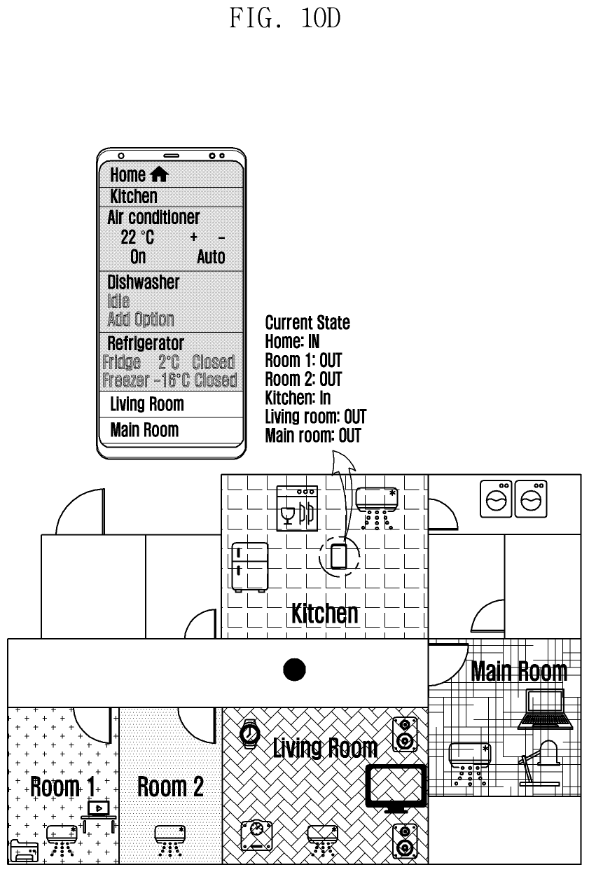

FIGS. 10A to 10D illustrate a method by which a processor (for example, the processor 220 of FIG. 2) determines whether an electronic device (for example, the electronic device 200 of FIG. 2) is located in a predetermined are according to certain embodiments.

According to an embodiment, the primary geo-fence may be a virtual geographical area set on the basis of a GPS locating, and the secondary geo-fence may be a predetermined area in detail by the user within the primary geo-fence. FIGS. 10A to 10D may be examples in the case in which the entire home is designated as the primary geo-fence, and the main room, the living room, the kitchen, room1, and room2 are designated as the secondary geo-fence.

In the example of FIG. 10A, the electronic device 200 may be located outside a home geo-fence (Home: primary geo-fence) which is a geographical area related to a user's home. As it is identified that the electronic device 200 is located outside the home geo-fence through a location sensor (e.g., for example, the location sensor 276 of FIG. 2), the processor 220 may determine all of the current information (current state) as “OUT”.

In the example of FIG. 10B, the electronic device 200 may be located inside the home geo-fence (Home: primary geo-fence) but may be located outside the secondary geo-fence related to the detailed area of the user's home. As it is identified that the electronic device 200 is located within the home geo-fence through the location sensor 276 and the electronic device 200 is located outside the secondary geo-fence since information on the external electronic device cannot be scanned for, the processor 220 may determine only “HOME” corresponding to the home geo-fence as “IN” and the remaining areas corresponding to the secondary geo-fence as “OUT” in the current information.

In the example of FIG. 10C, the electronic device 200 may be located in the living room in the secondary geo-fence. As the external electronic device (for example, TV in living room and air-conditioner in living room) is scanned for, the processor 220 may identify that the electronic device 200 is located in living room in the secondary geo-fence and determine the area of “living room” as “IN”. Further, as it is determined that the electronic device 200 is within the secondary geo-fence although location information is not acquired from the location sensor 276, the processor 220 may determine that the home is within the home geo-fence belonging to the secondary geo-fence and determine “HOME” as “IN”. In this case, even though the external electronic device (for example, refrigerator) located in the kitchen is scanned for, the processor 220 may determine living room which is the secondary geo-fence area to which the external electronic device (for example, air-conditioner in living room and TV) close to the electronic device belongings as “IN” state. The processor 220 may determine only one area of the secondary geo-fence areas as the “IN” state and remaining areas as “OUT”. According to an embodiment, the processor 220 may display a user interface (UI) corresponding to the secondary geo-fence area determined as “IN” on an application screen. Further, the processor 220 may display an external electronic device control UI in the order of closets external electronic devices located in the secondary geo-fence area. Referring to FIG. 10C, the electronic device 200 is located in living room, is close to an air-conditioner, and next close to a TV, and thus the processor 220 may display a UI related to living room on the top part of the application and display a UE related to the air-conditioner and the TV on the bottom part.

In the example of FIG. 10D, the electronic device 200 may be located in the kitchen in the secondary geo-fence. As external electronic devices (for example, kitchen air-conditioner, dish washer, and refrigerator) are scanned for, the processor 220 may identify that the electronic device 200 is located in the kitchen in the secondary geo-fence and determine the “kitchen” area as “IN”. Referring to FIG. 10D, since the electronic device 200 is located in the kitchen, is close to the kitchen air-conditioner, next close to the dish washer, and next close to the refrigerator, the processor 220 may display a UI related to the kitchen on the top part of the application and display a UI related to the kitchen air-conditioner, the dish washer, and the refrigerator on the bottom part.

The electronic device 200 according to certain embodiments of the disclosure may include the location sensor 276 configured to measure location information of the electronic device 200, the memory 230, and the processor 220 operatively connected to the location sensor 276, the memory 230, and the communication module 290, and the processor 220 may be configured to acquire identification information of one or more external electronic devices 300 included in a primary geo-fence and information on the external electronic devices 300 including relative distances between the external electronic devices 300 and the electronic device 200 from the communication module 290, determine location information of the one or more external electronic devices 300 on the basis of a location of the electronic device 200 and the relative distances, and generate at least a partial area including the external electronic device 300 in the primary geo-fence as a second geo-fence on the basis of the identification information of the external electronic devices 300 and the location information of the external electronic devices 300.

In the electronic device 200 according to certain embodiments of the disclosure, the processor 220 may be configured to determine whether the location information of the electronic device 200 measured by the location sensor 276 is reliable and acquire information on the external electronic devices 300 in accordance with determination that the location information is reliable.

The electronic device 200 according to certain embodiments of the disclosure may further include the motion sensor 277, and the memory 230 may be configured to store reliable location information including the location and accuracy of the electronic device 200, and the processor 220 may be configured to acquire a movement distance of the electronic device 200 from the motion sensor 277, determine a reliable location radius having a value obtained by adding the accuracy and the movement distance of the electronic device 200 as a semidiameter, and determine that the location information of the electronic device 200 acquired from the location sensor 276 is reliable in accordance with the location information included in the reliable location radius.

In the electronic device 200 according to certain embodiments of the disclosure, the motion sensor 277 may be configured to measure an activity type and an activity duration time of the electronic device 200, and the processor 220 may be configured to generate a calibration value on the basis of the activity duration time in accordance with the activity type of the electronic device 200 corresponding to a stationary state, and determine the reliable location radius having, as a semidiameter, a value obtained by adding an accuracy radius of the reliable location information and the calibration value.

In the electronic device 200 according to certain embodiments of the disclosure, the processor 220 may be configured to generate the secondary geo-fence, based on information including information on a move count that is a number of times the location of the external electronic device 300 escapes a predetermined range.

In the electronic device 200 according to certain embodiments of the disclosure, the processor 220 may be configured to learn the move count to determine a level of a movement probability of the external electronic device 300 and generate the secondary geo-fence, based on the level of the movement probability.

In the electronic device 200 according to certain embodiments of the disclosure, the processor 220 may be configured to learn location information of the external electronic device 300 and generate the secondary geo-fence, based on information including a valid state indicating whether the location information of the external electronic device 300 can be used for geo-fence determination.

In the electronic device 200 according to certain embodiments of the disclosure, the processor 220 may be configured to determine a valid state of the location information of the external electronic device 300 on the basis of a number of times the location information of the external electronic device 300 is included in a predetermined range.

In the electronic device 200 according to certain embodiments of the disclosure, the processor 220 may be configured to acquire information related to the secondary geo-fence from a server through the communication module 290 and transmit update information of the secondary geo-fence to the server.

The electronic device 200 according to certain embodiments of the disclosure includes the communication module 290 and the processor 220 operatively connected to the communication module 290, and the processor 220 may be configured to acquire information on an external electronic device 300 including identification information from the communication module 290, search for identification information of the external electronic device 300 in a secondary geo-fence included in a primary geo-fence, identify a valid state indicating whether location information of the external electronic device 300 corresponding to the identification information in the secondary geo-fence can be used for geo-fence determination in accordance with existence of the identification information in the secondary geo-fence, and determine whether the electronic device 200 is located in a predetermined area through the location information of the external electronic device 300 in accordance with an available state of the valid state.

A method of operating the electronic device 200 according to certain embodiments of the disclosure includes an operation of acquiring identification information of one or more external electronic devices 300 included in a primary geo-fence and information on the external electronic devices 300 including relative distances between the external electronic devices 300 and the electronic device 200, an operation of determining location information of the one or more external electronic devices 300 on the basis of a location of the electronic device 200 and the relative distances, and an operation of generating at least a partial area including the external electronic device 300 in the primary geo-fence as a second geo-fence on the basis of the identification information of the external electronic devices 300 and the location information of the external electronic devices 300.

The method of operating the electronic device 200 according to certain embodiments of the disclosure may include an operation of determining whether the location information of the electronic device 200 measured by the location sensor 276 is reliable and an operation of acquiring information on the external electronic devices 300 in accordance with determination that the location information is reliable.

The method of operating the electronic device 200 according to certain embodiments of the disclosure may include an operation of acquiring a movement distance of the electronic device 200 from the motion sensor 277, an operation of determining a reliable location radius having a value obtained by adding the accuracy and the movement distance of the electronic device 200 as a semidiameter, and an operation of determining that the location information of the electronic device 200 acquired from the location sensor 276 is reliable in accordance with the location information included in the reliable location radius.

The method of operating the electronic device 200 according to certain embodiments of the disclosure may include an operation of generating a calibration value, based on the activity duration time in accordance with the activity type of the electronic device 200 corresponding to a stationary state and an operation of determining the reliable location radius having, as a semidiameter, a value obtained by adding an accuracy radius of the reliable location information and the calibration value.

The method of operating the electronic device 200 according to certain embodiments of the disclosure may include an operation of generating the secondary geo-fence, based on information including information on a move count that is a number of times the location of the external electronic device 300 escapes a predetermined range.

The method of operating the electronic device 200 according to certain embodiments of the disclosure may include an operation of learning the move count to determine a level of a movement probability of the external electronic device 300 and an operation of generating the secondary geo-fence, based on the level of the movement probability.

The method of operating the electronic device 200 according to certain embodiments of the disclosure may include an operation of learning location information of the external electronic device 300 and an operation of generating the secondary geo-fence, based on information including a valid state indicating whether the location information of the external electronic device 300 can be used for geo-fence determination.

The method of operating the electronic device 200 according to certain embodiments of the disclosure may include an operation of determining a valid state of the location information of the external electronic device 300 on the basis of a number of times the location information of the external electronic device 300 is included in a predetermined range.

The method of operating the electronic device 200 according to certain embodiments of the disclosure may include an operation of acquiring information related to the secondary geo-fence from a server through the communication module 290 and an operation of transmitting update information of the secondary geo-fence to the server.

A method of operating the electronic device 200 according to certain embodiments of the disclosure may include an operation of acquiring information on the external electronic device 300 including identification information from the communication module 290, an operation of searching for identification information of the external electronic device 300 in a secondary geo-fence included in a primary geo-fence, an operation of identifying a valid state indicating whether location information of the external electronic device 300 corresponding to the identification information in the secondary geo-fence can be used for geo-fence determination in accordance with existence of the identification information in the secondary geo-fence, and an operation of determining whether the electronic device 200 is located in a predetermined area through the location information of the external electronic device 300 in accordance with an available state of the valid state.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with certain embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a location sensor;
a memory;
a communication module; and
a processor operatively connected to the location sensor, the memory, and the communication module,
wherein the processor is configured to:
receive, from the communication module, identification information of one or more external electronic devices included in a primary geo-fence, and relative distances between each of the one or more external electronic devices and the electronic device,
determine respective locations of the one or more external electronic devices, based on a location of the electronic device as detected via the location sensor, and the relative distances, and
determine a portion of the primary geo-fence as a secondary geo-fence inclusive of the one or more external electronic devices, based at least on the identification information and the respective locations of the one or more external electronic devices.

2. The electronic device of claim 1, wherein the processor is configured to:
determine whether the location of the electronic device measured by the location sensor meets a predetermined reliability threshold, and
acquire information on the one or more external electronic devices, including the relative distances, based on determining that the location meets the predetermined reliability threshold.

3. The electronic device of claim 2, further comprising a motion sensor,
wherein the memory is configured to store reliable location information including the location of the electronic device, and an accuracy value for the electronic device, and
wherein the processor is configured to:
acquire a movement distance of the electronic device via the motion sensor,
determine a reliable location circle by adding the accuracy value to the movement distance of the electronic device, and
wherein the predetermined reliability threshold is met when the location is disposed within the reliable location circle.

4. The electronic device of claim 3, wherein the processor is further configured to:
detect, via the motion sensor, an activity type and time duration corresponding to the movement distance,
generate a calibration value based on at least the activity type and the time duration, when the electronic device is detected to be stationary,
determine the reliable location circle by adding the calibration value to the movement distance and the accuracy value as centered on the location.

5. The electronic device of claim 1, wherein the processor is configured to generate the secondary geo-fence based on count of a number of times that a first external electronic device exits and reenters a predetermined area.

6. The electronic device of claim 5, wherein the processor is configured to:
generate a movement probability value based on the count,
wherein the secondary geo-fence is further generated based on the movement probability value.

7. The electronic device of claim 1, wherein the processor is further configured to:
determine the secondary geo-fence, based on information including a valid state indicating whether the location information of the one or more external electronic device can be used for geo-fence determination.

8. The electronic device of claim 7, wherein the processor is configured to determine a valid state of the location information of the one or more external electronic devices based at least on a respective count of times that each of the one or more external electronic devices detected to be within a predetermined range of value.

9. The electronic device of claim 1, wherein the processor is configured to:
receive information related to the secondary geo-fence from a server via the communication module, and
transmit update information for the secondary geo-fence to the server via the communication module.

10. An electronic device, comprising:
a communication module; and
a processor operatively connected to the communication module,
wherein the processor is configured to:
receive information on an external electronic device, including identification information for an external electronic device, via the communication module,
search a secondary geo-fence included in a primary geo-fence, for the identification information of the external electronic device,
based on detecting the identification information in the secondary geo-fence, identify a validity state of the external electronic device indicating whether location information of the external electronic device can be used for geo-fence determination, and
when the identified validity state indicates availability, determine whether the electronic device is located in a predetermined area based at least on the location information of the external electronic device.

11. A method of operating an electronic device, the method comprising:
acquiring, via communication circuitry, identification information of one or more external electronic devices included in a primary geo-fence;
acquiring, via at least one processor, respective relative distances between each of the one or more external electronic devices and the electronic device;
determining respective locations of each the one or more external electronic devices, based at least on a location of the electronic device and the respective relative distances; and
determining at least a portion of the primary geo-fence as a secondary geo-fence inclusive of the one or more external electronic devices, based at least on the identification information and the respective locations of the one or more external electronic devices.

12. The method of claim 11, further comprising:
determining whether the location of the electronic device measured by a location sensor meets a predetermined reliability threshold, and
acquiring information on the one or more external electronic devices, including the relative distances, based on determining that the location meets the predetermined reliability threshold.

13. The method of claim 12, further comprising:
storing reliable location information including the location of the electronic device, and an accuracy value for the electronic device, and
acquiring a movement distance of the electronic device via a motion sensor;
determining a reliable location circle by adding the accuracy value and the movement distance of the electronic device; and
wherein the predetermined reliability threshold is met when the location is disposed within the reliable location radius as centered on the location.

14. The method of claim 13, further comprising:
detecting, via the motion sensor, an activity type and time duration corresponding to the movement distance,
determining the reliable location circle by adding the calibration value to the movement distance and the accuracy value as centered on the location.

15. The method of claim 11, wherein the secondary geo-fence is further generated based on count of a number of times that a first external electronic device exits and reenters a predetermined area.

16. The method of claim 15, further comprising:
generating a movement probability value based on the count,
wherein the secondary geo-fence is further generated based on the movement probability value.

17. The method of claim 11, further comprising:
determining the secondary geo-fence, based on information including a valid state indicating whether the location information of the one or more external electronic device can be used for geo-fence determination.

18. The method of claim 17, further comprising:
determining a valid state of the location information of the one or more external electronic device, based at least on a respective count of times that each of the one or more external electronic devices detected to be within a predetermined range of value.

19. The method of claim 11, further comprising:
receiving information related to the secondary geo-fence from a server via a communication module, and
transmitting update information for the secondary geo-fence to the server via the communication module.

20. A method of operating an electronic device, the method comprising:
receiving, via communication circuitry, information on an external electronic device including identification information;
searching in a secondary geo-fence included in a primary geo-fence for the identification information;
based on detecting the identification information in the secondary geo-fence, identifying a validity state of the external electronic device, indicating whether location information of the external electronic device can be used for geo-fence determination; and
when the identified validity state indicates availability, determining whether the electronic device is located in a predetermined area based on the location information of the external electronic device.
